(19) United States
(12) Patent Application Publication
(10) Pub. No.: US 2004/0200989 A1
(43) Pub. Date: Oct. 14, 2004

(54) Water control gate

(76) Inventors: William Paul Camp JR., Findlay, OH (US); William Craig, Findlay, OH (US); Owen Michael Atchison, Findlay, OH (US); Howard Leander Montgomery, Findlay, OH (US)

Correspondence Address: H. Duane Switzer, Jones Day, North Point, 901 Lakeside Avenue, Cleveland, OH, 44114-1190, US

(21) Appl. No.: 10/410,898

(22) Filed: Apr. 10, 2003

(51) Int. Cl. F16K 3/02

(52) U.S. Cl. 251/326

(57) ABSTRACT

A water control gate assembled from hollow core boards of extruded rigid plastic material with soft plastic material gaskets chemically bonded thereto by molecular cross-linking. Side channel members that receive end portions of the boards are extruded of rigid plastic material with soft plastic gaskets chemically bonded thereto by molecular cross-linking. The gaskets seal against the outer surfaces of the board end portions. The gaskets are molecularly cross-linked with the board or side channel plastic material so that they will not separate therefrom. Cross-linking is achieved by way of coextrusion or by locally reheating surfaces of the board or channel member downstream from their extrusion die to a temperature that promotes molecular cross-linking with a gasket material as the gasket is extruded onto the reheated area.

### BACKGROUND OF THE INVENTION

This application relates to the art of water level control and, more particularly, to controlling water levels of drainage basins. The invention is particularly applicable to water control gates and will be described with specific reference thereto. However, it will be appreciated that the invention has broader aspects, and that certain features and components thereof may be used for other purposes in other environments.

Water control gates are used for controlling the water level in a pond, lake or drainage area. Such water control gates commonly are fabricated from a plurality of boards so that the height of the control gate may be varied by adding or removing boards. Such control gates also may be disassembled and then reassembled elsewhere.

Components of water control gates are subject to corrosion, deterioration and to bowing of the boards. Even conventional plastic boards may bow over time due to plastic creep, and the degree of bowing of individual boards differs because of higher water pressure on the boards near the bottom of the gate compared to the boards near the top of the gate.

Gasketing between adjacent boards and end channels tend to stick to other components when left in place for long periods of time. Adhesive bonds between gaskets and other components, as well as gaskets placed in a groove, are subject to separation. All of these characteristics raise problems when it is desired to disassemble a gate and reassemble same. Warpage of boards makes it very difficult to reassemble a gate unless individual boards are reassembled in the same order that they were removed. Disassembly of a gate often results in tearing or separation of gaskets so that they do not provide an effective seal if the gate is reassembled without performing extensive maintenance and reconditioning.

It would be desirable to provide a water control gate that minimizes these and other problems.

### SUMMARY OF THE INVENTION

In accordance with the present application, a water control gate is fabricated of chemically inert non-corrosive materials. Hollow core tongue and groove rigid plastic boards have integral soft gaskets chemically bonded thereto by molecular cross-linking between the compatible plastic materials used for the rigid board and the soft gasket. The bond may be obtained by coextrusion of the board and gaskets, or by locally reheating the board downstream from the board die to a temperature that promotes molecular cross-linking with the soft gasket material as it is extruded onto the reheated area.

The hollow core boards have a plurality of individual cells that are separated by longitudinally-extending ribs to provide a very rigid lightweight board. The board includes a core that is co-extruded with a thin outer skin having an infrared radiation inhibitor incorporated therein. The core may be of a recycled plastic material or a non-colored virgin plastic material while the skin is of a co-extruded virgin plastic material. However, it will be appreciated that the boards can be of a single material with an infrared inhibitor.

Side channel members that receive end portions of the boards to form a water control gate have a plurality of flexible finger gaskets and bump gaskets for sealing against outer surfaces of board end portions that are received in the side channel members. The rigid side channel members and the flexible gaskets may be co-extruded of compatible plastic materials to obtain a chemical bond with molecular cross-linking therebetween, or surfaces of the channel member may be locally reheated downstream from the channel member extrusion die to a temperature that promotes molecular cross-linking when the gaskets are extruded onto the reheated area.

The finger gaskets and bump gaskets work in concert with one another. The finger gaskets center the boards within the channel of the channel member and allow easy insertion of the boards. The gaskets within a channel of a channel member work in both directions, and this eliminates the need to carefully assemble a gate to be sure that it properly faces the high pressure side.

The gaskets within a channel of a channel member are self-activating in response to pressure acting on the boards. The finger gaskets are effective at low pressure, and the bump gaskets are operative at high pressure when the boards move in the downstream direction by deflecting the downstream finger gaskets and bottoming out against the bump gaskets. Pressure acting on the boards increases the pressure on the downstream finger and/or bump gaskets to automatically increase the seal.

It is a principal object of the present invention to provide an improved water control gate.

It is another object of the invention to provide a water control gate of chemically inert non-corrosive materials.

It is a further object of the invention to provide an improved hollow core plastic board having integral gaskets co-extruded therewith.

It is also an object of the invention to provide the lightweight hollow plastic board with gaskets that do not bulge outwardly of the opposite faces of the boards.

It is an additional object of the invention to provide improved side channel members for use in assembling water control gates.

It is also an object of the invention to provide side channel members with integral co-extruded finger gaskets and bump gaskets for sealing against outer surfaces of board end portions.

It is still a further object of the invention to provide board receiving channels with self-activating seals that respond to pressure on the boards.

It is another object of the invention to provide board receiving channel members that work in both backward and forward directions of pressure on the boards.

It also is an object of the invention to provide board receiving channels with gaskets that easily allow insertion of boards without the need to compress gaskets to start a board into the channel.

It is still another object of the invention to provide board receiving channel members with gaskets that allow self-centering of the boards, and that automatically increase the sealing effectiveness in response to increasing pressure on the boards.

It is another object of the invention to provide an improved arrangement for attaching side channel members within a vertical riser pipe.

### BRIEF DESCRIPTION OF THE DRAWING

FIG. 1 is top plan view of a water control structure having the improved water control gate of the present application installed therein;

FIG. 2 is a cross-sectional elevational view taken generally on line 2-2 of FIG. 1;

FIG. 3 is a partial cross-sectional elevational view taken generally on line 3-3 of FIG. 1 and showing a hollow board used in the water control gate of the present application;

FIG. 4 is an end elevational view of the board of FIG. 3;

FIG. 5 is an enlarged end elevational view of the tongue portion of the board of FIGS. 3 and 4;

FIG. 6 is an enlarged end elevational view of the groove portion of the board of FIGS. 3 and 4, and with the gaskets omitted for clarity of explanation;

FIG. 7 is an end elevational view of one gasket used on the board of FIGS. 3 and 4 adjacent the groove of FIG. 6, with the other gasket being a mirror image of the one shown in FIG. 7;

FIG. 8 is a cross-sectional elevational view showing a tongue and groove joint between two of the boards shown in FIG. 3 prior to the joint being bottomed out;

FIG. 9 is a view similar to FIG. 4 showing the joint of FIG. 8 with the boards bottomed out and the gaskets compressed;

FIG. 10 is an end elevational view of a side channel member used in the water control gate of the present application;

FIG. 11 is an enlarged partial end elevational view showing a gasket receiving groove in the side channel member of FIG. 10;

FIG. 12 is a view similar to FIG. 10 and showing how gasket members are attached to the side channel member;

FIG. 13 is a top plan view showing the side channel member of FIG. 10 installed in a cylindrical riser pipe having a certain diameter;

FIG. 14 is a view similar to FIG. 13 and showing the side channel member installed in a cylindrical riser pipe having a different diameter;

FIG. 15 is a view similar to FIG. 13 and showing the side channel member installed in a cylindrical riser pipe having still another diameter;

FIG. 16 is an end elevational view showing a finger gasket that forms a part of the side channel member of FIG. 13;

FIG. 17 is an end elevational view of a bump gasket incorporated in the side channel member of FIG. 13;

FIG. 18 is a top plan view showing the gate of the present application installed in a riser pipe;

FIG. 19 is a top plan view showing one end portion of a board received in a channel in the side channel member of FIG. 13;

FIG. 20 is a partial cross-sectional elevational view showing an alternative arrangement for bonding and sealing the side channel to the interior of a cylindrical riser pipe by injecting adhesive into a side channel groove;

FIG. 21 is a perspective illustration of another water control structure;

FIG. 22 is a partial cross-sectional plan view showing a channel member attached inside of the riser pipe in the water control structure of FIG. 21;

FIG. 23 is an end elevational view of a tongue portion of a board;

FIG. 24 is an end elevational view of another tongue portion of a board;

FIG. 25 is an end elevational view of another groove portion of a board;

FIG. 26 is an end elevational view showing the board tongue portion of FIG. 5 received in the board groove portion of FIG. 25;

FIG. 27 is an end elevational view showing the board tongue portion of FIG. 24 received in the board groove portion of FIG. 25;

FIG. 28 is an end elevational view of another board;

FIG. 29 is an end elevational view showing a tongue and groove joint between boards of FIG. 28, and with gaskets uncompressed;

FIG. 30 is a view similar to FIG. 29 with the gaskets compressed;

FIG. 31 is an end elevational view of another board;

FIG. 32 is an end elevational view showing a tongue and groove joint between boards of FIG. 31, and with gaskets uncompressed;

FIG. 33 is a view similar to FIG. 32 with the gaskets compressed;

FIG. 34 is an end elevational view of another finger gasket;

FIG. 35 is an end elevational view of still another finger gasket;

FIG. 36 is an end elevational view of another bump gasket;

FIG. 37 is an end elevational view showing the finger gasket of FIG. 34 and the bump gasket of FIG. 36 within a board receiving channel of a channel member; and

FIG. 38 is an end elevational view showing the finger gasket of FIG. 35 and the bump gasket of FIG. 36 within a board receiving channel of a channel member.

### DESCRIPTION OF REPRESENTATIVE EMBODIMENTS

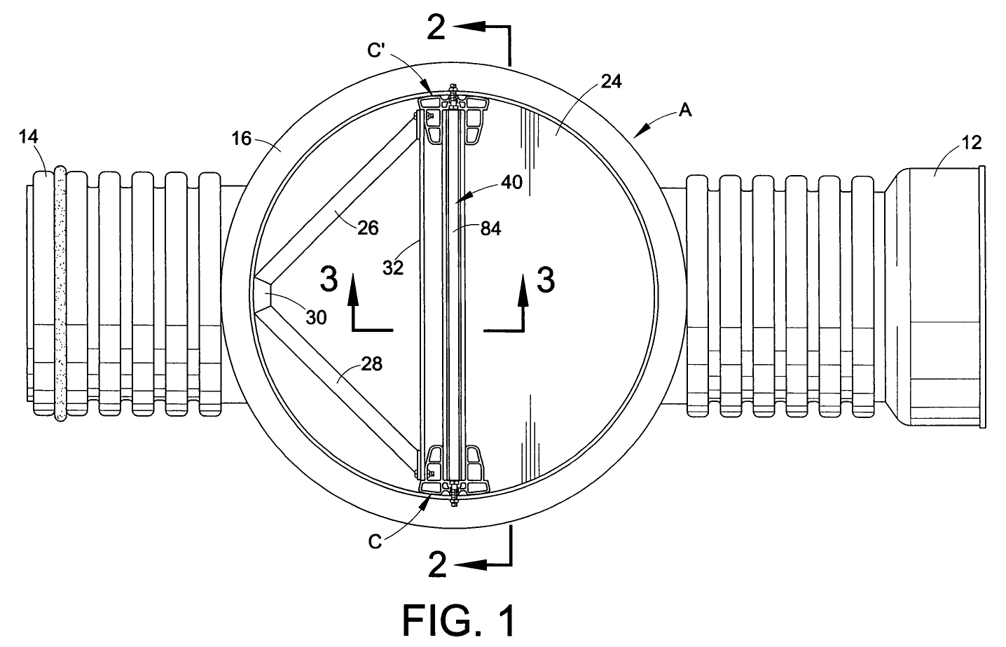

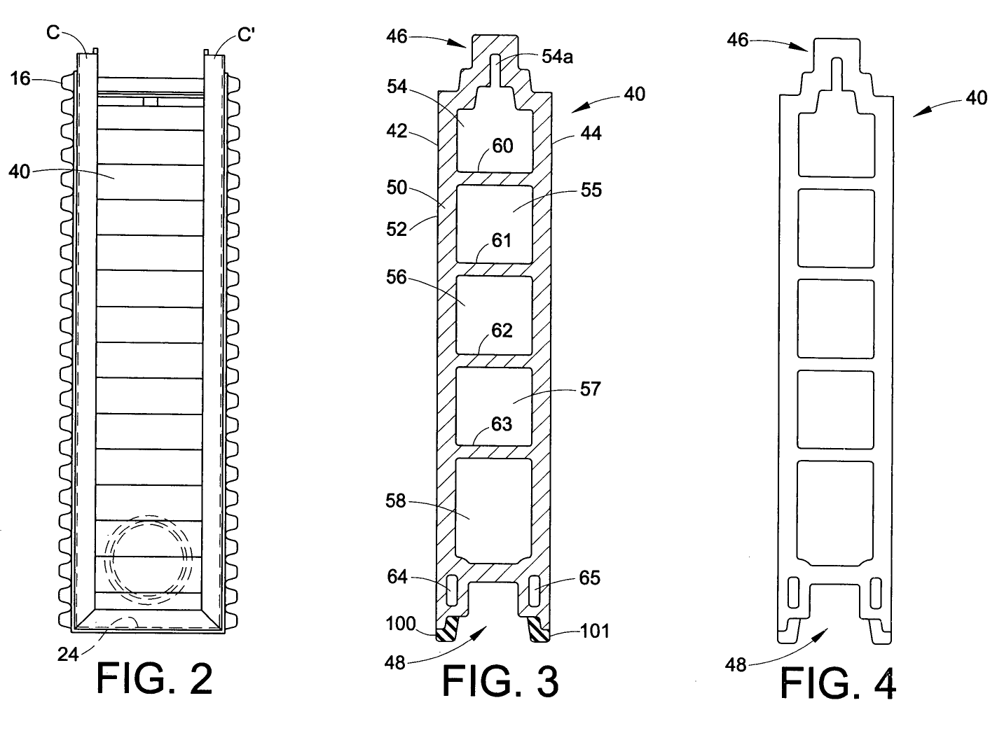

Referring now to the drawing, wherein the showings are for purposes of illustrating representative embodiments of the present invention only and not for purposes of limiting same, FIG. 1 shows a water control structure A having inlet and outlet pipes 12, 14 and a vertical riser pipe 16.

Although all of the pipes are shown as being generally cylindrical, it will be appreciated that they may have other shapes and that water control structures commonly are used with square or rectangular riser pipes 16. All of pipes 12, 14 and 16 are illustrated as being externally corrugated pipes having smooth internal cylindrical surfaces. However, it will be appreciated that non-corrugated pipes or other types of pipes may be used with the water control gate of the present application. These pipes commonly are made of high density polyethylene, also known as HDPE, or rigid polyvinylchloride, also known as PVC, although other materials may be used.

A pair of vertically positioned opposed side channel members C and C′ are secured within riser pipe 16 and extend upwardly from riser pipe flat bottom 24. Channel members C and C′ may be braced by brace members 26, 28 that are attached to channel members C and C′ and to a brace support 30 that is secured within riser pipe 16 midway between side channel members C and C′. A cross brace 32 extends between channel members C and C′, and interconnects the ends of brace members 26, 28.

A plurality of generally flat boards 40 have their end portions received in inwardly opening channels in side channel members 20, 22. The boards are shaped to provide horizontal tongue and groove joints between adjacent boards. The height of the water control gate in a direction upwardly from riser pipe bottom 24 is adjustable by varying the number of boards 40 that are used.

As shown in FIG. 3, each board 40 has parallel opposite plane faces 42, 44, along with a longitudinally extending tongue 46 and an opposite longitudinally extending cooperatively shaped groove 48. Both the tongue and groove extend the full length of the board between the opposite ends thereof. Board 40 has a core 50 and a thin outer skin 52 that are coextruded of chemically compatible plastic materials so that the core and skin are chemically bonded by molecular cross-linking.

By way of example, core 50 and outer skin 52 may be coextruded of polyvinylchloride, commonly known as PVC, with outer skin 52 having suitable ultraviolet ray inhibitors such as titanium oxide or carbon black incorporated therein. The plastic material used for outer skin 52 may have a higher impact resistance than the material used for core 50. For example, the outer skin material may have an Izod impact strength of 13 foot pounds per inch while the inner core material has an Izod impact strength of 3.0 foot pounds per inch. Core 50 may be extruded from recycled plastic material or a non-colored virgin plastic material, while skin 52 may be a virgin plastic material, although a single plastic material containing an infrared inhibitor may be used throughout the board.

Board 40 has a hollow interior with a plurality of individual hollow cells 54, 55, 56, 57 and 58 extending longitudinally of the board between the opposite ends thereof and being separated from one another by internal ribs 60, 61, 62 and 63. Ribs 60-63 extend parallel to one another and are perpendicular to board faces 42, 44. Hollow cell 54 extends into tongue 46 as indicated at 54a so that the tongue itself is hollow. Smaller hollow cells 64 and 65 are provided in the core of board 40 adjacent groove 48. All of the hollow cells extend the full length of the board between the opposite ends thereof.

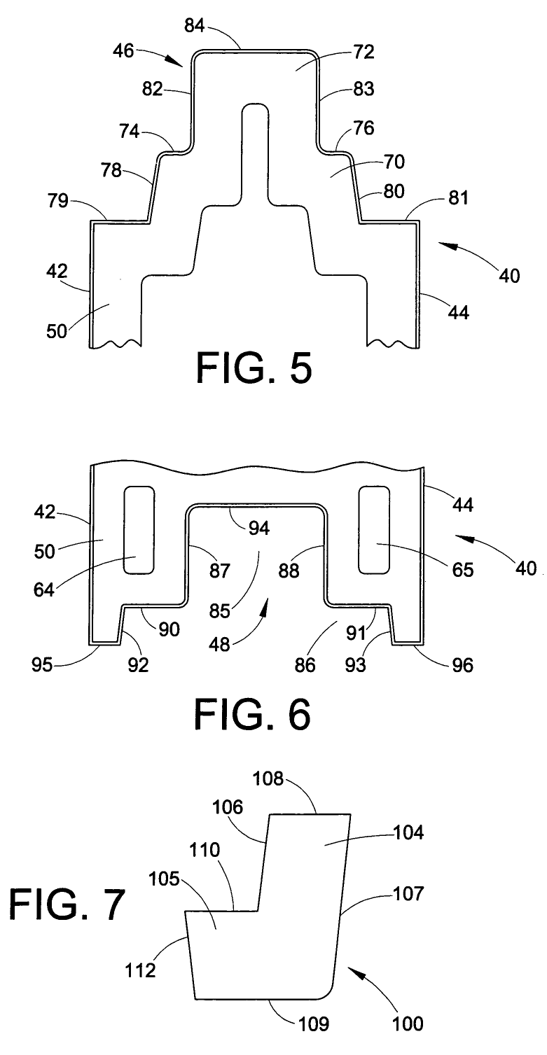

Board tongue 46 is stepped so that it includes a first tongue portion 70 that is stepped inwardly from board outer surfaces 42, 44 and a narrower terminal tongue portion 72 projecting centrally from first tongue portion 70. As shown in FIG. 5, terminal tongue portion 72 has a width that is smaller than the width of first tongue portion 70 so that the first and terminal tongue portions intersect at shoulders 74, 76 that extend generally perpendicular to plane parallel outer board surfaces 42, 44.

First tongue portion 70 has opposite outwardly facing sloping tongue surfaces 78, 80 that slope outwardly in a direction from shoulders 74, 76 to intersection with shoulders 79, 81 that in turn intersect board outer surfaces 42, 44 and extend perpendicular thereto. Each of shoulders 79, 81 has a width that is generally the same as the thickness of board core 50. The opposite outer faces 82, 83 of terminal tongue portion 72 extend generally parallel to one another and to plane outer faces 42, 44 of board 40. Terminal tongue portion 72 has a flat terminal end 84 that extends generally perpendicular to the outwardly facing surfaces 82, 83 of the terminal tongue portion 72.

As shown in FIG. 6, groove 48 also is stepped to cooperatively mate with tongue 46. Groove 48 includes an inner groove portion 85 and an outer groove portion 86. Inner groove portion 85 has a width between parallel groove sidewalls 87, 88 that is smaller than the width of outer groove portion 86, and the two groove portions intersect one another at outwardly extending shoulders 90, 91 that form a bottom for outer groove portion 86 and extend in a direction generally perpendicular to plane parallel outer board surfaces 42, 44. The opposite sidewalls 92, 93 of outer groove portion 86 slope outwardly from shoulders 90, 91 at generally the same slope as sloping surfaces 78, 80 on first tongue portion 70 of FIG. 5.

Inner groove 85 has a groove bottom 94 that extends generally perpendicular to groove sidewalls 87, 88. Sloping outer groove sidewalls 92, 93 intersect parallel board ends 95, 96 that extend generally perpendicular to board outer surfaces 42, 44.

Elastomeric gaskets 100, 101 are bonded to the groove end of the board as shown in FIGS. 3 and 4. With reference to FIG. 7, gasket 100 has a generally backward L shape, and gasket 101 is a mirror image thereof. Gasket 100 has an upright leg 104 and a lateral leg 105. Upright leg 104 has parallel surfaces 106, 107 that are inclined at generally the same angle as sloping groove sidewall 90 and tongue surface 78. Outer end 108 of upright leg 104 extends generally parallel to gasket bottom surface 109. Lateral leg 105 has an upper surface 110 extending generally parallel to upright leg end 108 and gasket bottom surface 109. Lateral leg outer end 112 is inclined inwardly from upper surface 110 toward gasket bottom surface 109 at a small angle such as around 2°.

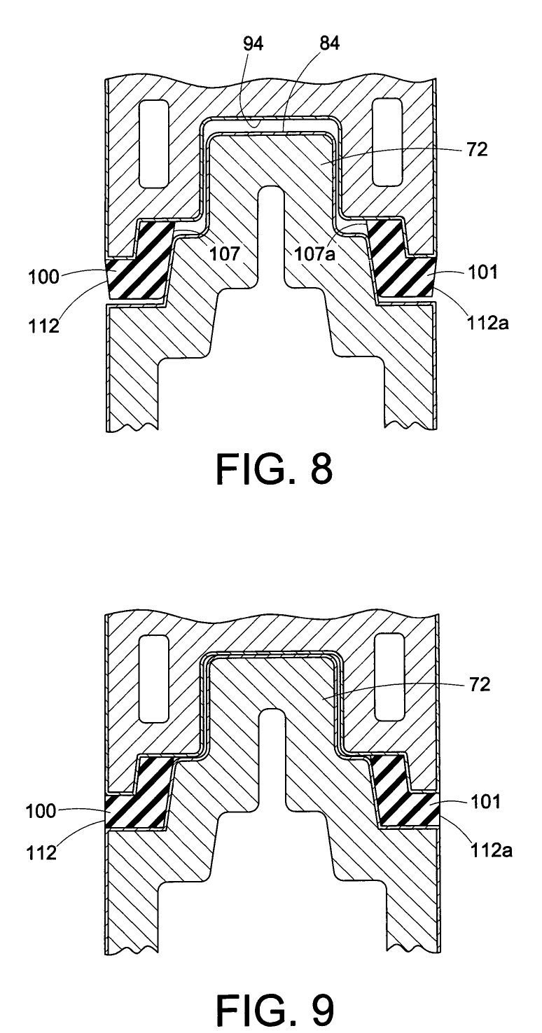

Gaskets 100 and 101 are dimensioned such that interference occurs when a tongue and groove reach the position generally shown in FIG. 8. The gaskets are compressed when the tongue and groove joint is bottomed out as shown in FIG. 9. When the gaskets are compressed, gasket inclined outer surfaces 112 and 112a assume the positions shown in FIG. 9 essentially flush with the board outer surfaces. Absent the original inclination, the gaskets would bulge outwardly beyond the board outer surfaces and interfere with sealing of the boards within side channel members C and C′.

Gaskets 100, 101 may be coextruded with board 40 so that they chemically bond with the board material by molecular cross-linking. In the alternative, the board may be locally reheated downstream from the board extrusion die as the board exists from the vacuum sizer and is still quite warm. The soft vinyl gasket is extruded onto the reheated area of the board to obtain a good chemical bond with molecular cross-linking.

The PVC used for gaskets 100, 101 is a flexible PVC, such as Roscom PVC 605-75 with a Shore A durometer hardness of 75±3, so that the gaskets are elastomeric or rubber-like. Board 40 is extruded of rigid PVC such as Crane Plastics R108 Rigid PVC with a flexural modulus of 370,000 psi that produces a rigid board. The board with the elastomeric gaskets is a one-piece integral product because the board and gaskets are of chemically compatible plastic materials that are bonded together by molecular cross-linking by way of coextrusion or by locally reheating of the board to a temperature that promotes molecular cross-linking when a gasket is extruded onto the reheated area.

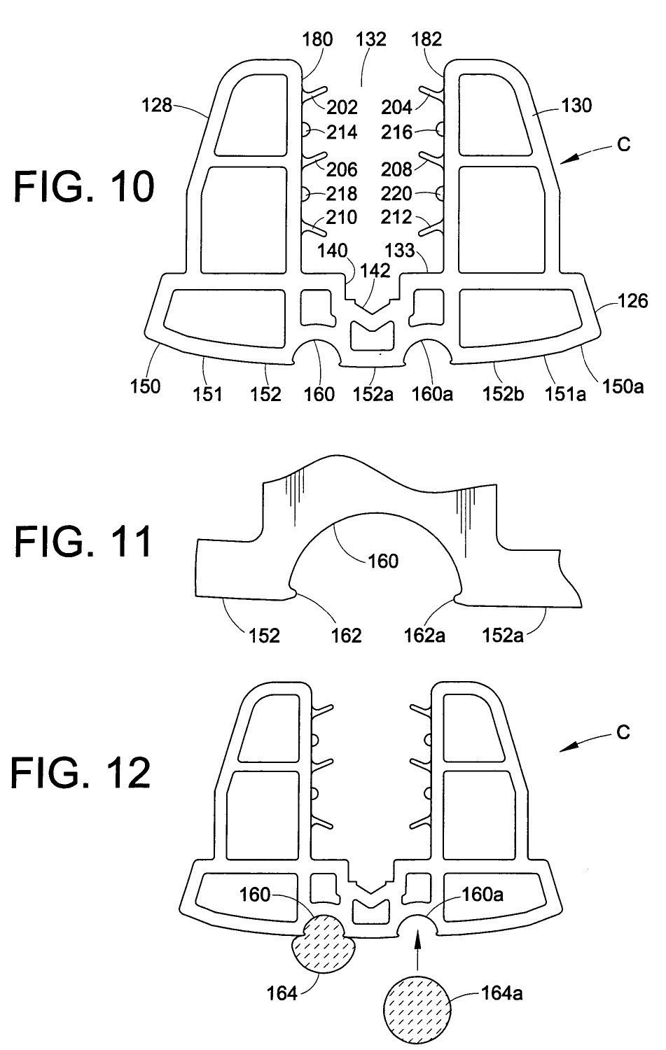

FIG. 10 shows a channel member C having a generally U-shaped cross-sectional configuration with a base 126 and spaced-apart opposite legs 128, 130 with a generally rectangular channel 132 therebetween for receiving an end portion of a board 40. Channel member C is extruded of a suitable plastic material such as the rigid Crane Plastics PVC described above, and with hollow cells extending the length of the channel member as shown in FIG. 10.

The base 133 of channel 132 in channel member C has a centrally located longitudinally extending generally rectangular groove 140 therein with a longitudinally extending generally V-shaped bottom groove 142. Groove 142 facilitates centering of a drill bit for drilling longitudinally-spaced holes through channel member base 126 to receive bolts. Flat surfaces on the polygonal head of the bolt cooperate with the sidewalls of groove 140 to prevent rotation of the bolt when a nut is threaded thereon.

The outer surface of channel member base 126 is arcuately curved at a plurality of different radii as generally indicated at 150 and 150a, 151 and 151a, and at 152, 152a and 152b. The different curvatures provide engagement of the channel member base with cylindrical internal surfaces of riser pipes having different diameters.

A pair of longitudinally extending arcuate gasket receiving grooves 160, 160a are provided in the outer surface of channel member base 126. Gasket receiving grooves 160 and 160a open outwardly between a pair of longitudinally extending inwardly projecting gasket retainers 162, 162a as shown in FIG. 11. A compressible foam gasket having a generally cylindrical cross-sectional shape as shown at 164, 164a in FIG. 12 is receivable in each groove 160, 160a and is retained therein by retainer projections 162, 162a.

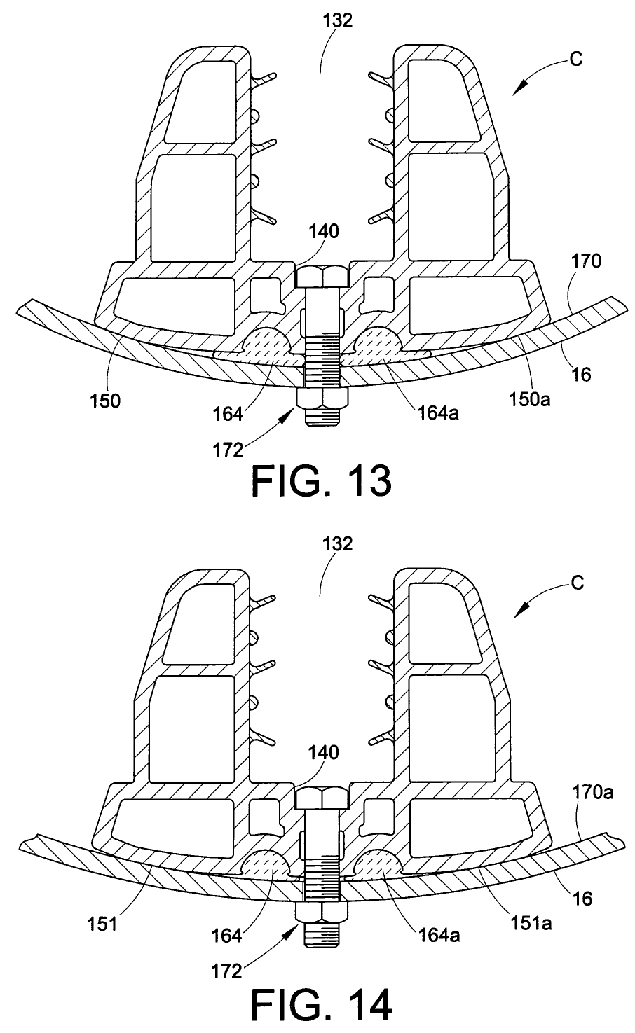

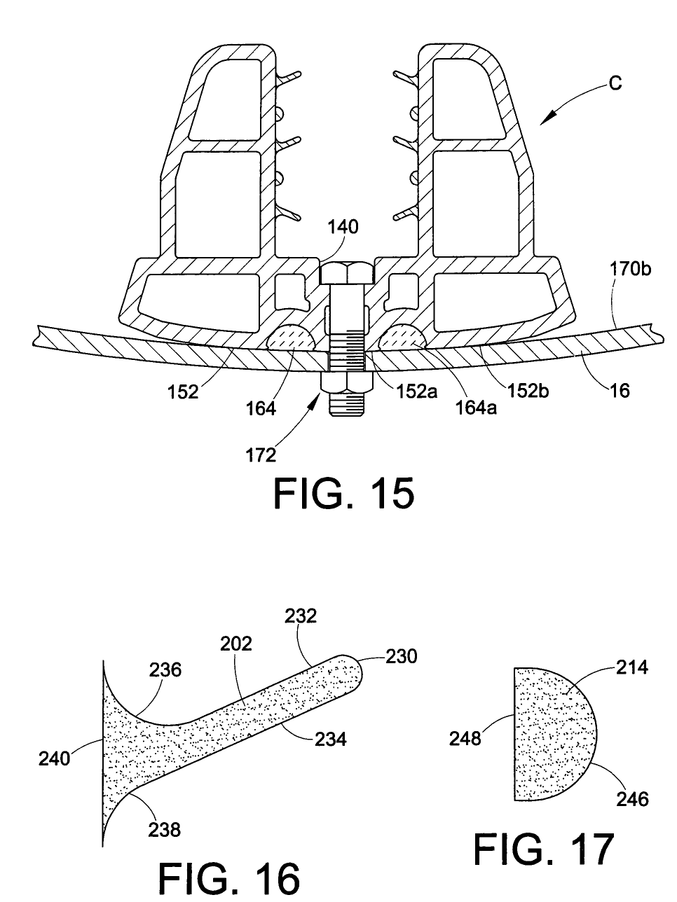

FIG. 13 shows channel member base outer surfaces 150, 150a engaging an internal cylindrical surface 170 of a riser pipe 16 having one diameter. FIG. 14 shows outwardly facing surfaces 151, 151a on channel member base 126 engaging cylindrical internal surface 170a having a different diameter than internal surface 170 of FIG. 13. FIG. 14 shows surfaces 152, 152a and 152b engaging internal surface 170b of riser pipe 16 having still another diameter.

A plurality of vertically-spaced bolt and nut assemblies 172 secure the channel members within a riser pipe. Suitable holes are drilled through a channel member and the riser pipe for receiving the bolt which is extended through the holes from the inside of the riser pipe. The flat sides of a square or hexagonal bolt head cooperate with the sides of rectangular groove 140 to prevent rotation of the bolt when the nut is threaded thereon.

The thickness of the bolt head axially of the bolt also is not greater than the depth of groove 140 so that the outer surface of the bolt head is either flush with or preferably recessed below the surface of channel bottom 133. This insures that the bolt head will not interfere with the ends of the boards when they are inserted into a channel 132. The groove 140 and the bolt head are sized such that flat surfaces on the bolt head engage the sides of groove 140 to hold the bolt against rotation when a nut is threaded thereon. This eliminates the need to use a tool for holding the bolt against rotation when a nut is threaded thereon.

Channel 132 in channel member C has longitudinally extending opposite parallel plane channel sidewall surfaces 180, 182. A plurality of resilient elastomeric finger gaskets and bumper gaskets are provided on walls 180, 182. The gaskets may be coextruded with channel member C of a compatible plastic material so that all of the gaskets are chemically bonded to channel member C by molecular cross-linking. The sidewall surfaces 180, 182 of channel 132 also may be locally reheated downstream from the channel member extrusion die as the channel member exits from the vacuum sizer and is still quite warm. The channel member surfaces are reheated to a temperature that provides a good chemical bond with molecular cross-linking when a soft vinyl gasket is extruded onto the reheated area of the channel member. The flexible gaskets may be of the aforementioned Roscom PVC 605-75 plastic material.

As shown in FIG. 10, the finger gaskets and bump gaskets are arranged in opposed pairs extending inwardly from side wall surfaces 180, 182 of channel 132. Finger gaskets 202, 204, 206 and 208 are inclined in a direction away from channel bottom 133 and toward the open end of channel 132. Finger gaskets 210 and 212 are inclined in an opposite direction toward channel bottom 133 and away from the open end of channel 132. Half-round bump gaskets 214, 216, 218 and 220 are located midway between adjacent sealing lips.

Side channel member C, the finger gaskets and the bump gaskets are of compatible plastic materials so that the soft vinyl gaskets are molecularly cross-linked with the rigid PVC plastic material of the channel member by way of coextrusion or locally reheating surfaces of the channel member to a temperature that promotes molecular cross-linking when a gasket is extruded onto the reheated area.

As shown in FIG. 16, finger gasket 202 has a rounded outer end 230 and parallel opposite surfaces 232, 234 that diverge along curved areas 236, 238 to intersection with a wide flat base 240 along which the finger gasket is molecularly bonded to the plastic material of the side channel member.

FIG. 17 shows a half-round bump gasket 214 having a smoothly curved outer surface 246 and a flat base 248 along which the bump gasket is molecularly bonded to the plastic material of the side channel member.

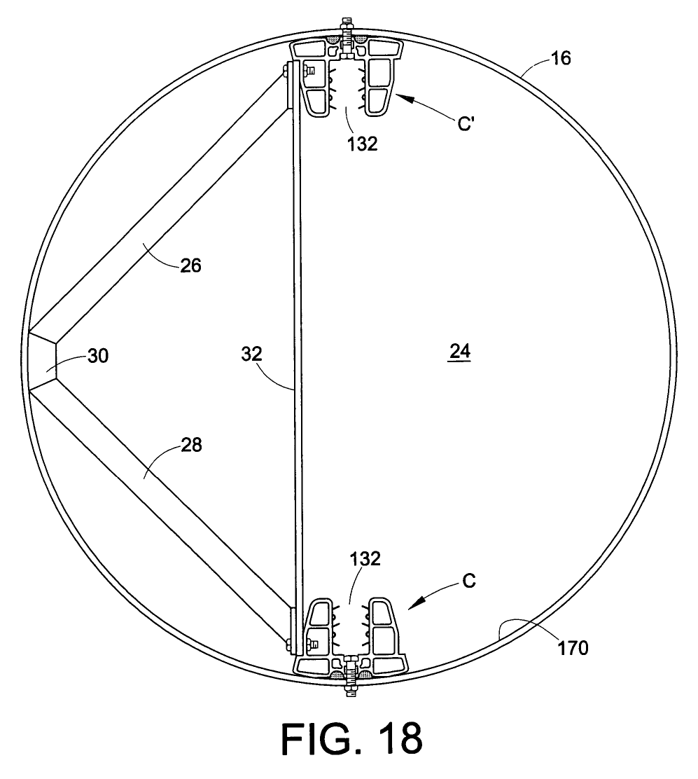

FIG. 18 is a top plan view showing side channel members installed within a vertical riser pipe for receiving a plurality of boards within channels 132, 132′ to form a water control gate of desirable vertical height.

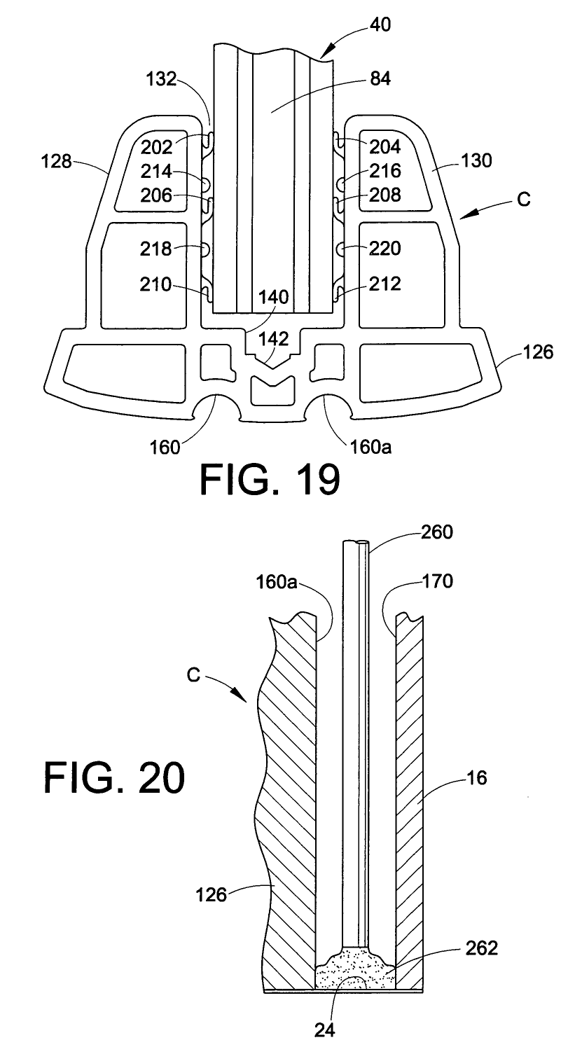

FIG. 19 shows an end portion of a board 40 received within a channel 132 in a side channel member C. Outer surfaces 42, 44 of the board end portion sealingly engage the finger gaskets within channel 132. The boards and channels are dimensioned such that the outer surfaces of the boards either have a slight clearance between bump gaskets 214, 216 and 218, 220, or lightly engage same. When water pressure acts on the boards, such as from right-to-left in FIG. 19, the boards will be forced into sealing engagement with bump gaskets 214 and 218 on the downstream side of the boards. The boards and finger gaskets are dimensioned to provide flexing of the finger gaskets as shown in FIG. 19 when the board end portions are inserted into the channels the gaskets 100, 101 on the bottom board seal against bottom 24 and riser pipe 16.

FIG. 20 shows another arrangement for sealing a side channel member within a riser pipe. A tube 260 is inserted into a groove 160 of a channel member C that is positioned within a riser pipe 16 having an internal surface 170. An adhesive material 262 is injected into groove 160 through tube 260, and tube 260 is withdrawn as the adhesive material continues to flow into the groove to fill same. This provides a watertight seal while also securing the side channel member within the riser pipe.

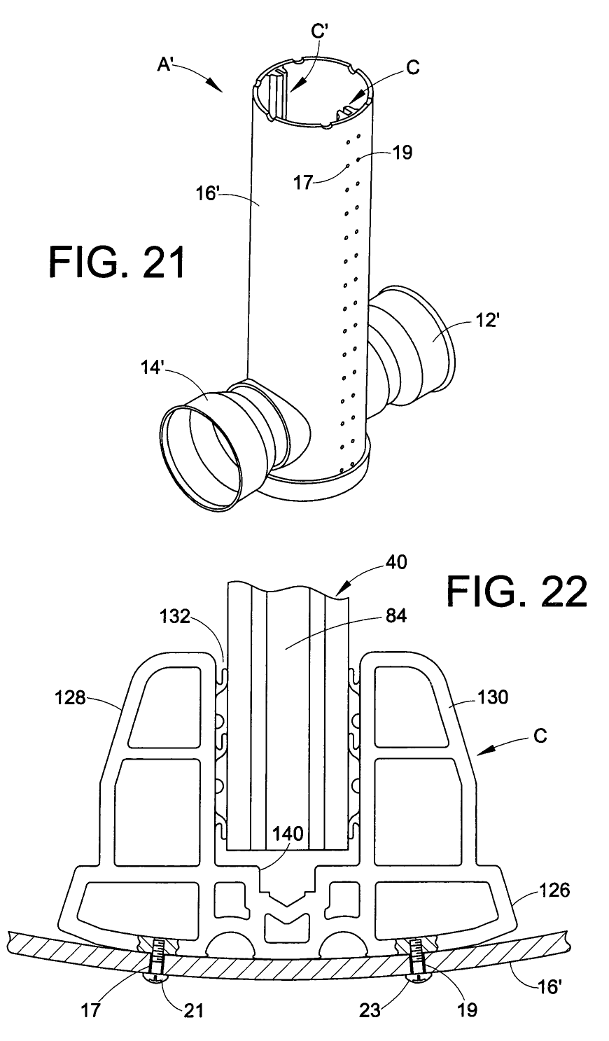

FIG. 21 shows another water control gate structure A′ having inlet and outlet pipes 12′, 14′ and a riser pipe 16′. Water control structure A′ is advantageously molded of PVC plastic material of the type previously mentioned. Channel members C, C′ are solvent welded opposite one another to the inner surface of riser pipe 16′.

Circumferentially-spaced vertical rows of screw receiving holes 17, 19 are provided in the wall of riser pipe 16′ in alignment with the location of channel members C, C′. It will be understood that corresponding rows of screw receiving holes are provided in riser pipe 16′ 180° opposite from rows 17, 19.

The surfaces of channel members C, C′ that face the interior surface of riser pipe 16′ are coated with PVC solvent, and the channel members then are positioned against the inner surface of riser pipe 16′. Self-tapping screws then are inserted through the holes in rows 17, 19 and threaded into channel members C, C′ to firmly hold the channel members against the inner surface of riser pipe 16′ while the solvent weld forms to firmly fuse and bond the channel members to the inner surface of the riser pipe. The primary purpose of the screws is to hold the channel members against the inner surface of the riser pipe while the solvent weld takes effect and not to structurally secure the channel members to the riser pipe. Obviously, other ways of firmly holding the channel members against the inner surface of the riser pipe while the solvent weld takes effect are possible. The holes in each row may be 6-12 inches apart. In one arrangement, the hole rows have been approximately 3 1/16 inch apart, although it will be recognized that both the hole and row spacing may vary.

FIG. 22 shows a channel member C solvent welded to the interior surface of riser pipe 16′. Self-tapping screws 21, 23 extend through holes 17, 19 into channel member C for firmly holding channel member C against the interior surface of riser pipe 16′ while the solvent weld takes effect.

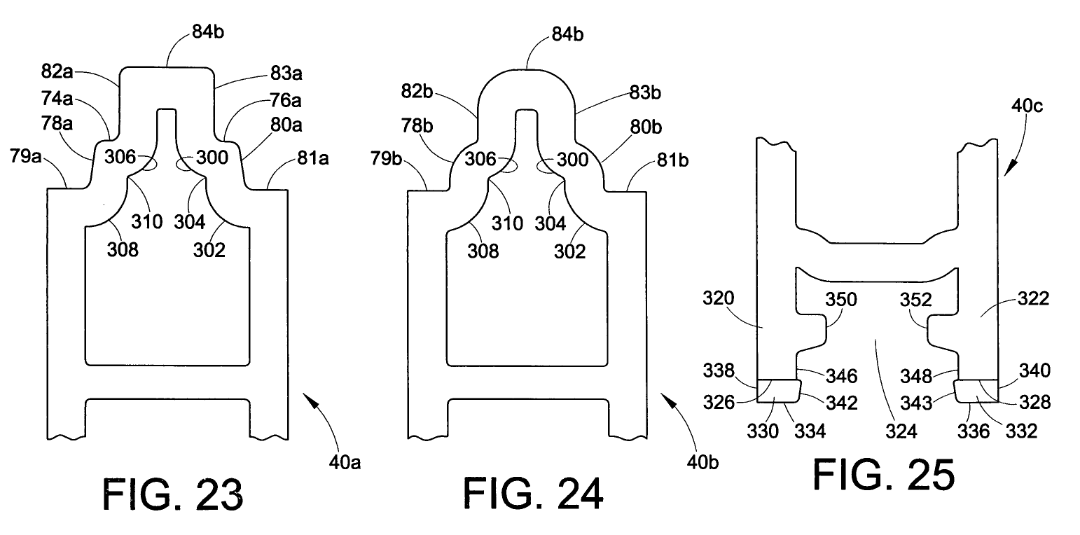

FIG. 23 shows a modified board 40A having a modified tongue portion. The external shape of the tongue portion is the same as that described with reference to FIG. 5. However, the interior of the tongue portion is curved instead of being stepped as in the arrangement of FIG. 5. Inner surface 300 is smoothly curved generally opposite from the inside corner intersection between outer surfaces 76a, 83a. Inner surface 302 also is smoothly curved generally opposite from the inside corner intersection between outer surfaces 80a, 82a. Inner curved surfaces 300, 302 intersect at an inwardly extending cusp 304 generally opposite from the outside corner intersection between outer surfaces 76a, 80a. Inner surface 306 is curved generally opposite from the inside corner intersection between outer surfaces 74a, 82a. Inner surface 308 is smoothly curved generally opposite from the inside corner intersection between outer surfaces 78a, 81a. Inner curved surfaces 306, 308 meet at an inwardly extending cusp 310 generally opposite from the outside corner intersection between outer surfaces 74a, 78a.

FIG. 24 shows another board 40B having a modified tongue portion with an outer end portion 84b that is smoothly curved to intersect with outer surfaces 82b, 83b. Outer surfaces 76a, 80a and 74a, 78a of FIG. 23 are replaced with an outwardly curved surface 78b, 80b that extends between outer surfaces 83b, 82b and 82b, 81b.

FIG. 25 shows another board 40C having a different groove portion. In this arrangement, board 40C has spaced-apart parallel groove end wall portions 320, 322 between which tongue receiving groove 324 is formed. Bottom ends 326, 328 of board wall portions 320, 322 have elastomeric gaskets 330, 332 bonded thereto. Each gasket has a bottom end 334, 336 and an outer surface 338, 340 that is inclined inwardly from board ends 326, 328 toward gasket bottom ends 334, 336 at a small angle such as around 2°. Gaskets 330, 332 have inner surfaces 342, 343 that project inwardly of inner surfaces 346, 348 of board wall portions 320, 322. Gasket inner surfaces 342, 343 are inclined outwardly toward the outer surface of the board in a direction from board wall portion ends 326, 328 toward gasket bottom ends 334, 336. Opposite joint stabilizing projections 350, 352 extend toward one another within socket 324.

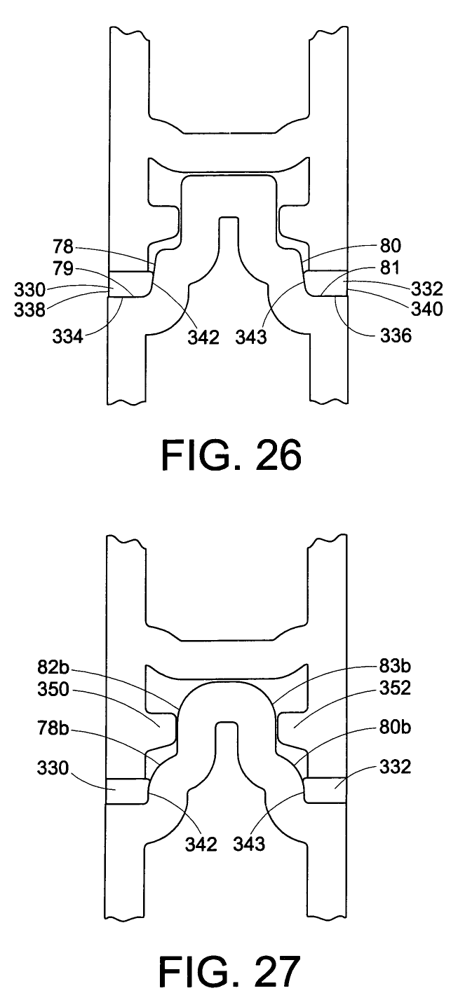

FIG. 26 shows the tongue of FIG. 5 received in the groove of FIG. 25. Gasket inner surfaces 342, 343 engage outer surfaces 78, 80 on the tongue. Gasket bottom surfaces 334, 336 engage tongue surfaces 81, 82. FIG. 26 shows the joint with the tongue and groove simply assembled without compressing the gaskets. Once the joint is fully inserted to compress the gaskets, inclined gasket outer surfaces 338, 340 will deform outwardly to be essentially flush with the outer surfaces of the boards.

FIG. 27 shows the tongue of FIG. 24 received in the groove of FIG. 25 without compression of the gaskets. In this arrangement, gasket inner surfaces 342, 343 engage curved outer surfaces 78b, 80b on the tongue. Tongue outer surfaces 82b, 83b are closely received between groove projections 350, 352 to stabilize the joint and minimize lateral movement thereof.

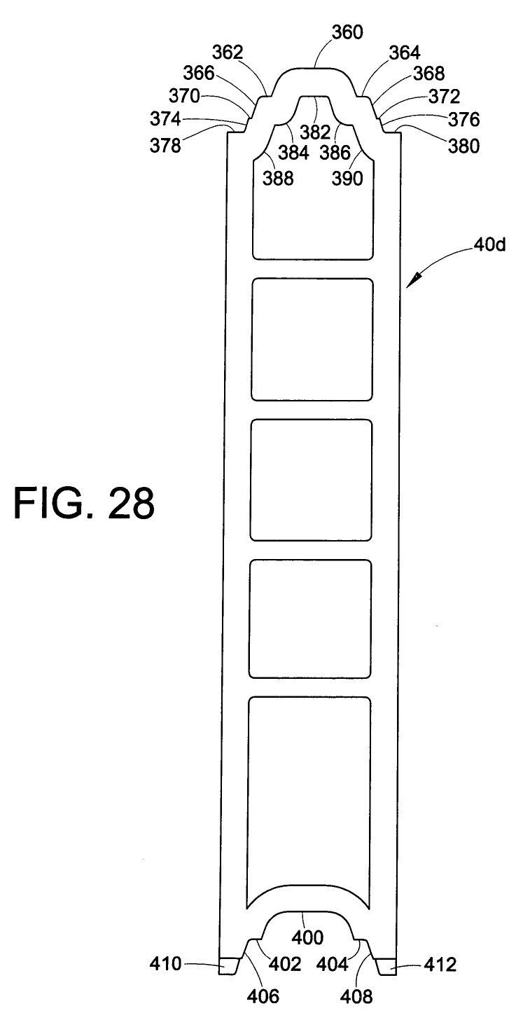

FIG. 28 shows another board 40D having a horizontal tongue outer end 360 that is smoothly curved downwardly to intersection with horizontal shoulders 362, 364 followed by outwardly inclined portions 366, 368 that intersect with much smaller horizontal shoulders 370, 372. Outwardly inclined surfaces 374, 376 extend from smaller shoulders 370, 372 to intersection with horizontal shoulders 378, 380.

The inner surface of the tongue has a horizontal surface 382 opposite from horizontal outer surface 360. Outwardly curved surfaces 384, 386 generally opposite from shoulders 362, 364 intersect at inwardly extending cusps with outwardly curved surfaces 388, 390 located generally opposite from the intersections of surfaces 374, 376 with shoulders 378, 380.

The socket has a socket bottom 400 that is generally shaped to be complimentary with the outer surface of the tongue. Socket shoulders 402, 404 are located to mate with tongue shoulders 362, 364. Socket inclined surfaces 406, 408 are located to cooperate with tongue inclined surfaces 366, 368. Gaskets 410, 412 have gasket bottom surfaces that engage tongue shoulders 378, 380, and inclined gasket inner surfaces corresponding to those described with reference to 342, 343 in FIG. 25, and that engage tongue inclined surfaces 374, 376.

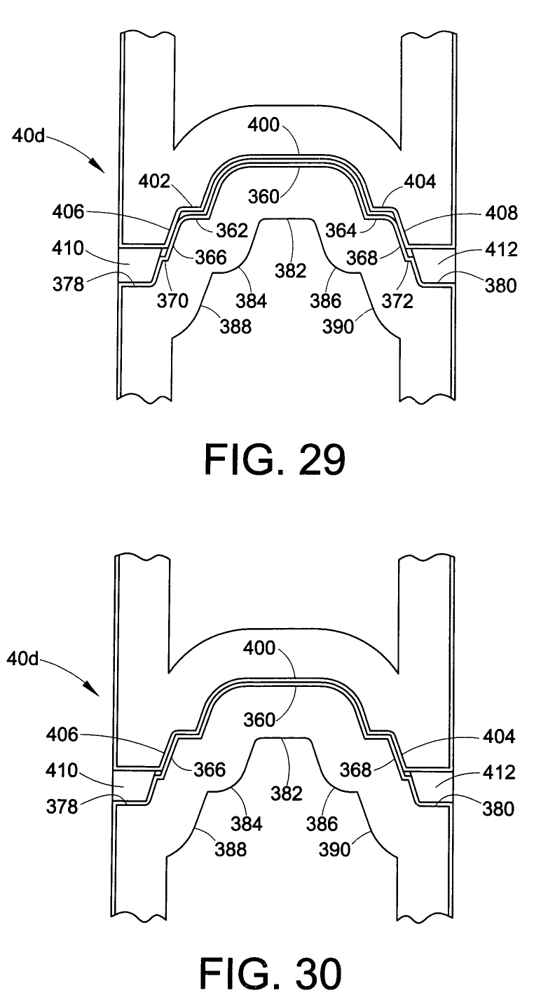

FIGS. 29 and 30 show the joint between boards having tongue and groove shapes as shown in FIG. 28. In FIG. 29, the joint is assembled without compression of the gaskets so that the gasket outer surfaces still are inclined slightly inwardly. In FIG. 30, the joint is fully made with the gaskets compressed so that the gasket outer surfaces are substantially flush with the board outer surfaces.

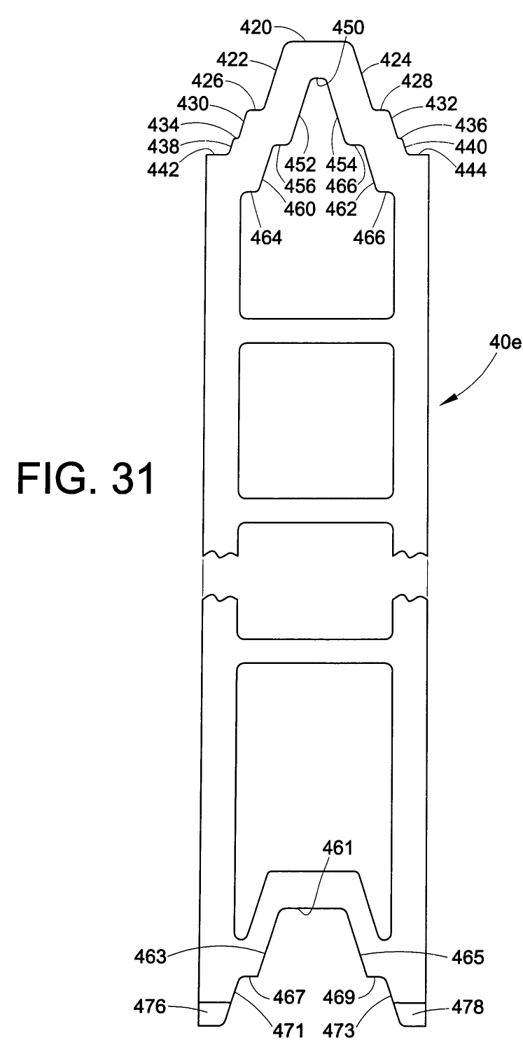

FIG. 31 shows another board 40E having a tongue with a horizontal outer end 420 that intersects with outwardly inclined surfaces 422, 424 which intersect horizontal shoulders 426, 428. Outwardly inclined surfaces 430, 432 extend from shoulders 426, 428 to intersection with much smaller horizontal shoulders 434, 436 followed by outwardly inclined surfaces 438, 440 that intersect horizontal shoulders 442, 444. The tongue has a small horizontal inner surface 450 opposite from horizontal outer surface 420 and outwardly inclined inner surfaces 452, 454 that intersect with shoulders 456, 458 followed by outwardly inclined surfaces 460, 462 that intersect shoulders 464, 466.

A complimentary groove for the tongue includes a horizontal groove bottom 460 and outwardly inclined surfaces 462, 464 that intersect with shoulders 466, 468 followed by outwardly inclined surfaces 470, 472 that intersect with gaskets 476, 478.

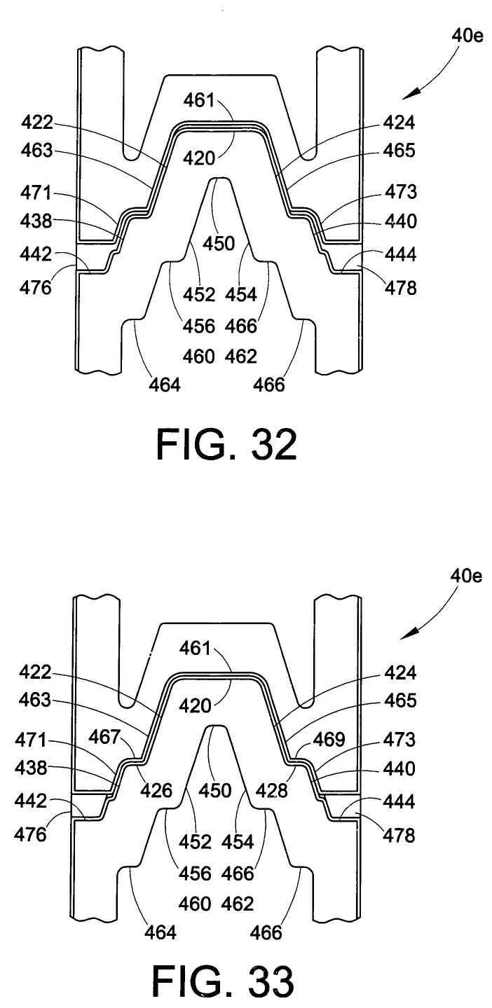

FIGS. 32 and 33 show the joint between adjacent boards having the tongue and groove arrangement of FIG. 31. FIG. 32 shows the joint assembled without compression of the gaskets and FIG. 33 shows full engagement of the joint with the gaskets compressed so that their inclined outer surfaces are substantially flush with the board outer surfaces.

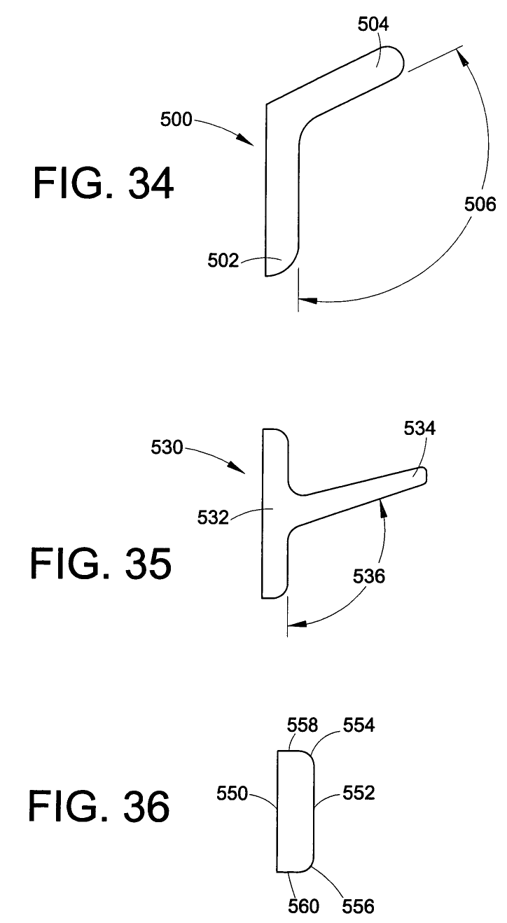

FIG. 34 shows a flexible finger gasket 500 having an attachment leg 502 and a flexible finger 504. Attachment leg 502 and flexible finger 504 intersect one another at an included angle of approximately 114 degrees. Obviously, this angle may vary and preferably is greater than 90 degrees to ensure proper flexing of finger portion 54 in a direction to increase the included angle between the flexible finger and the mounting leg so that the flexible finger does not overlie attachment leg 502.

FIG. 35 shows another flexible finger gasket having an attachment base 532 with a flexible finger 534 extending outwardly centrally thereof. Flexible finger and base 532 intersect at an included angle 536 of approximately 107 degrees. Obviously, this angle may vary but preferably is greater than 90 degrees to ensure proper sealing action of the flexible finger.

FIG. 36 shows a bump gasket having an inner attachment surface 550 and a plain outer surface 552 that is smoothly curved at 554, 556 to intersect with ends 558, 560.

The gaskets of FIGS. 34-36 may be co-extruded with a channel member or may be extruded onto a locally reheated surface area of a channel member. In either case, the gasket material is chemically bonded with the channel member plastic material by way of molecular cross-linking.

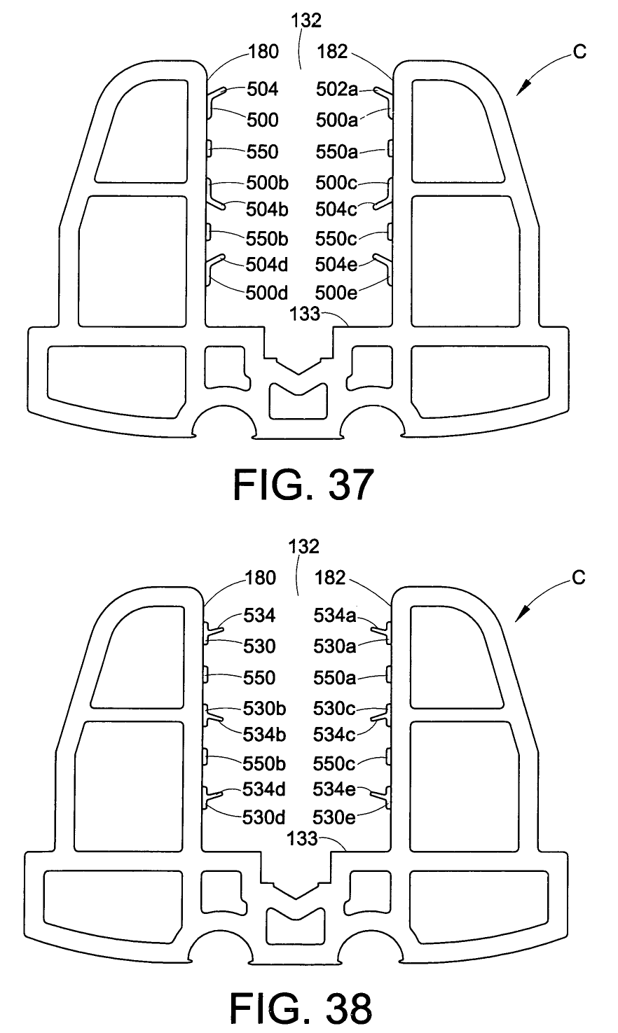

FIG. 37 shows a plurality of the finger gaskets of FIG. 34 and bump gaskets of FIG. 36 within a board receiving channel of a channel member. Finger gaskets 504 and 504a are located opposite one another on channel surfaces 180, 182. Finger gaskets 500b, 500c also are located opposite one another as are finger gaskets 500d, 500e. Bump gaskets 550, 550a are located opposite one another as are bump gaskets 550b, 550c. The bump gaskets are located intermediate finger gaskets as shown in FIG. 37. Gasket flexible fingers 504, 504a, 504d and 504e are inclined in a direction outwardly toward the open end of channel 132. Finger gaskets 500b, 500c are reversely positioned so that their flexible fingers 504b, 504c are inclined inwardly toward the channel bottom 133. The thickness of the bump gaskets may be approximately the same as the thickness of attaching portions 502 of finger gaskets 500. Flexible fingers 504 also have a thickness that is approximately the same as the thickness of attaching portions 502.

In the arrangement of FIG. 38, finger gaskets 530, 530a are located opposite one another on channel walls 180, 182. Finger gaskets 530b, 530c are opposite one another as are finger gaskets 530d, 530e. Flexible fingers 534, 534a, 534d and 534e are inclined outwardly in a direction toward the open end of channel 132. On the other hand, intermediate finger gaskets 530b and 530c have their flexible fingers 534b and 534c inclined inwardly in a direction toward channel bottom 133. Bump gaskets 550, 550a, 550b and 550c are located intermediate the finger gaskets.

The gasket arrangements of FIGS. 37 and 38 permit easy insertion of board end portions from the top open ends of a channel member without having to manually compress any of the gaskets. The gaskets also provide self-centering of the board end portions. When pressure acts on one side of a board, the board moves toward one or the other of channel walls 180, 182 so that the flexible fingers flex toward their respective channel wall. Under sufficient water pressure, the outer surface of the board will contact the bump gaskets to provide a very good seal. The seal is enhanced by increasing water pressure.

In the tongue and groove arrangement for the board of FIGS. 5-9, gasket engaging shoulders 79, 81 sealingly engage the bottoms of gaskets 100, 101. Inwardly inclined surfaces 78, 80 extend upwardly from gasket engaging shoulders 79, 81 and sealingly engage the inner surfaces of the gaskets. This provides at least two sealing surfaces between each gasket and tongue. Secondary shoulders 74, 76 are located intermediate gasket engaging shoulders 79, 81 and tongue end 84. The tongue, groove and gasket arrangements of FIGS. 23-33 have corresponding gasket engaging shoulders, gasket engaging inclined surfaces extending upwardly from the gasket engaging shoulders, and secondary shoulders between the tongue end and the gasket engaging shoulders.

Although the invention has been shown and described with reference to a representative embodiment, it is obvious that equivalent alterations and modifications will occur to others skilled in the art upon the reading and understanding of this application. Therefore, it is to be understood that the invention may be practiced otherwise than as specifically described herein while remaining within the scope of the claims.

We claim:

1. A water control gate comprising: a vertical wall formed by a plurality of hollow plastic boards having interdigitated tongue and groove joints between adjacent boards.

2. The gate of claim 1 wherein each said board has a hollow tongue.

3. The gate of claim 1 wherein each of said hollow plastic boards has a plurality of internal stiffening ribs.

4. The gate of claim 1 including elastomeric board gaskets between adjacent ones of said boards adjacent said tongue and groove joints.

5. The gate of claim 1 wherein each said board has a stepped tongue including a first tongue portion adjacent said board and a terminal tongue portion projecting centrally from said first tongue portion, and said terminal tongue portion having a width that is smaller than the width of said first tongue portion.

6. The gate of claim 5 wherein said first and terminal tongue portions intersect at shoulders and said first tongue portion has sloping tongue surfaces that slope outwardly in a direction from said shoulders toward said board.

7. The gate of claim 1 wherein each said board has a stepped groove including an inner groove portion and an outer groove portion, said inner groove portion having a width smaller than said outer groove portion, said inner groove portion intersecting said outer groove portion at outwardly extending shoulders that form a bottom of said outer groove portion, said outer groove having opposite sides with terminal ends and inner surfaces, and elastomeric board gaskets bonded to said terminal ends and to said inner surfaces.

8. The gate of claim 7 wherein said gaskets are coextruded with each said board.

9. The gate of claim 8 wherein said boards and said gaskets are coextruded of the same type of plastic material and the gasket plastic material is cross-linked with the board plastic material.

10. The gate of claim 7 wherein said board has opposite faces that intersect said terminal ends at edges, and said board gaskets having outwardly facing gasket surfaces that slope inwardly from said edges.

11. The gate of claim 1 wherein each of said hollow plastic boards has a plurality of individual hollow cells separated from one another by internal ribs extending longitudinally of each board.

12. The gate of claim 1 wherein each said board is extruded of an internal plastic material and a different external skin plastic material.

13. The gate of claim 12 wherein said internal plastic material is recycled plastic material.

14. The gate of claim 12 wherein said external skin plastic material includes an ultraviolet ray inhibitor.

15. The gate of claim 1 including a pair of spaced-apart vertical plastic channel members having inwardly open vertical channels, said boards having opposite end portions received in said channels, said boards having opposite faces, and said channels having elastomeric channel lips sealingly engaging said faces.

16. The gate of claim 15 wherein said channels have channel entrance openings, channel bottoms and channel sides, said channel lips including a plurality of spaced-apart channel lips extending into said channels from each of said channel sides, said plurality of channel lips on each of said channel sides including inclined lips that are inclined in generally opposite directions.

17. The gate of claim 15 wherein said channel members are made of rigid PVC and said sealing lips are made of flexible PVC.

18. The gate of claim 15 wherein each said channel member is coextruded with said sealing lips and the sealing lip plastic material is cross-linked with the channel member plastic material.

19. The gate of claim 15 wherein each of said channel members has a curved external surface for mating with a generally cylindrical internal surface of a pipe, and said curved external surface on each of said channels being configured to cooperate with generally cylindrical surfaces of pipes having a plurality of different internal diameters.

20. The gate of claim 15 wherein each said channel member includes at least one external longitudinally extending shoulder for cooperating with a reinforcing brace.

21. The gate of claim 15 wherein each said inwardly open vertical channel has a channel bottom, a centrally located longitudinal groove in said channel bottom for receiving a bolt head with the outer surface of the bolt head flush with or recessed below said channel bottom, said groove having groove sides for cooperation with flats on a bolt head to hold the bolt against rotation when a nut is threaded thereon.

22. The gate of claim 21 wherein said groove has a groove bottom with a centrally located longitudinal V-shaped groove therein for receiving a drill bit tip to facilitate drilling centrally located bolt receiving holes through said channel member.

23. The gate of claim 1 wherein each said board includes flexible gaskets bonded to each said board for sealing adjacent said tongue and groove joints, both said boards and said gaskets being of PVC.

24. A hollow board of plastic material, said board having a top end with a tongue therealong and a bottom end with a groove therealong for receiving a tongue on an adjacent board, said board having a pair of board ends on opposite sides of said groove, elastomeric gaskets attached to said board ends, said gaskets having gasket bottom ends and gasket inclined inner surfaces, said board having gasket engaging shoulders on opposite sides of said tongue and inclined tongue surfaces adjacent said gasket engaging shoulders, said gasket engaging shoulders and tongue inclined surfaces on an adjacent board being sealingly engaged with said gasket bottom ends and said gasket inclined inner surfaces when the tongue on an adjacent board is received in the groove.

25. The board of claim 24 wherein said gaskets are chemically bonded to said board by molecular cross-linking.

26. The board of claim 25 wherein said board has a core of a first plastic material and an outer skin of a second plastic material that includes an ultraviolet ray inhibitor.

27. The board of claim 24 wherein said tongue includes a tongue end, and secondary shoulders on opposite sides of said tongue intermediate said tongue end and said gasket engaging shoulders.

28. A hollow channel member of plastic material, said channel member having a channel with a channel opening, a channel bottom and opposite channel sidewalls, elastomeric finger gaskets on said sidewalls, said finger gaskets including flexible fingers that are inclined toward at least one of said channel opening or said channel bottom.

29. The channel of claim 28 wherein said finger gaskets include attachment legs that are attached to said channel sidewalls, said flexible fingers extending inwardly of said channel from said attachment legs at an included angle therewith that is greater than 90°.

30. The channel of claim 28 wherein said finger gaskets are chemically bonded to said channel sidewalls by molecular cross-linking.

31. The channel of claim 28 wherein each channel sidewall has at least three said finger gaskets attached thereto in spaced-apart relationship.

32. The channel member of claim 31 including bump gaskets attached to said channel sidewalls intermediate said finger gaskets.

33. The channel member of claim 31 wherein said finger gaskets include outer finger gaskets located adjacent said channel opening, bottom finger gaskets located adjacent said channel bottom and intermediate finger gaskets located intermediate said outer and bottom finger gaskets, said outer and bottom finger gaskets having said flexible fingers thereon inclined in a direction toward said channel opening, and said intermediate finger gaskets having said flexible fingers thereon inclined in a direction toward said channel bottom.

34. The channel member of claim 28 including a centrally located generally rectangular groove in said channel bottom.

35. The channel member of claim 34 wherein said groove has a groove bottom, and a centrally located generally V-shaped groove in said groove bottom.

36. The channel member of claim 28 wherein said channel member has a curved outer surface that includes at least two different curvatures that lie on different sized cylinders.

37. The channel member of claim 28 wherein said channel member has an outer surface with a pair of spaced-apart longitudinal external grooves therein for receiving a sealing material.

38. A water gate control structure including a riser pipe having a longitudinal axis and an inner surface, a pair of opposite hollow channel members of plastic material secured against said inner surface, said channel members having channels therein that open outwardly toward one another for receiving board end portions to form a control gate within said riser pipe, said channels having channel open ends, channel bottoms and parallel spaced-apart channel sidewalls, gaskets attached to said channel sidewalls and extending into said channels, and said channel members being sealed against said riser pipe inner surface.

39. The structure of claim 38 wherein said channel members are sealed against said riser pipe inner surface by adhesive.

40. The structure of claim 38 wherein said channel members are sealed against said riser pipe by longitudinal gaskets carried by said channel members and located between said channel members and said riser pipe inner surface.

41. The structure of claim 38 wherein said channel members are sealed against said riser pipe inner surface by a solvent weld.

42. The structure of claim 38 wherein said channel bottoms have centrally located generally rectangular longitudinal grooves therein with groove bottoms, a plurality of longitudinally-spaced channel member holes through said channel members in said groove bottoms, said riser pipe having pipe sidewall holes aligned with said channel member holes, bolts received in the aligned holes, said bolts having bolt heads received in said channel grooves, said bolt heads having bolt head outer surfaces that are flush with or recessed below said channel bottoms, said groove having groove sidewalls, and said bolt heads having bolt head flats located closely adjacent said groove sidewalls to hold said bolts against rotation when nuts are threaded thereon externally of said riser pipe.

43. The structure of claim 38 wherein said gaskets are chemically bonded to said channel sidewalls by molecular cross-linking.

44. The structure of claim 43 wherein said gaskets have flexible fingers thereon, some of said flexible fingers on some said gaskets being inclined outwardly toward said channel open ends and others of said flexible fingers on others of said gaskets being inclined inwardly toward said channel bottoms.

45. The structure of claim 38 wherein said gaskets include finger gaskets and bump gaskets that alternate with one another on each of said channel sidewalls.

46. The structure of claim 38 wherein said riser pipe is cylindrical and said channel members have outer surfaces that are curved to match the cylindrical curvature of said riser pipe.
